(19) United States
(12) Patent Application Publication
(10) Pub. No.: US 2005/0197784 A1
(43) Pub. Date: Sep. 8, 2005

(54) Methods and systems for analyzing term frequency in tabular data

(76) Inventors: Robert Kincaid, Half Moon Bay, CA (US); Aditya Vailaya, Santa Clara, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/794,724

(22) Filed: Mar. 4, 2004

(51) Int. Cl. G06F 7/00; G06F 17/30; G06F 19/00

(52) U.S. Cl. 702/19; 707/1; 702/20

(57) ABSTRACT

Systems, methods and recordable media for facilitating user-guidance of statistical analysis of large datasets based upon word-based textual annotations associated with the large datasets. Particular applications to large biological datasets are described.

### FIELD OF THE INVENTION

The present invention pertains to manipulation of large datasets. More particularly, the present invention pertains to systems, methods and recordable media for manipulation of large biological datasets to identify one or more interesting or potentially biologically meaningful subsets of the large dataset.

### BACKGROUND OF THE INVENTION

The advent of new experimental technologies that support molecular biology research have resulted in an explosion of data and a rapidly increasing diversity of biological measurement data types. Examples of such biological measurement types include gene expression from DNA microarray, Quantitative Polymerase Chain Reaction (PCR) experiments or Taqman experiments, protein identification from mass spectrometry or gel electrophoresis, cell localization information from flow cytometry, phenotype information from clinical data or knockout experiments, genotype information from association studies and DNA microarray experiments, etc. This data is rapidly changing. New technologies frequently generate new types of data.

Molecular biologists working in this area need to assimilate knowledge from a dramatically increasing amount and diversity of biological data. In addition to data from their own experiments, biologists also utilize a rich body of available information from Internet-based sources, e.g. genomic, proteomic, and pathway databases, and from the scientific literature.

Biologists may use these experimental data and numerous other sources of information to piece together interpretations and form hypotheses about biological processes. Such interpretations and hypotheses constitute higher-level models of biological activity. Such models can be the basis of communicating information to colleagues, for generating ideas for further experimentation, and for predicting biological response to a condition, treatment, or stimulus.

One approach into organizing large data sets such as those generated by high throughput techniques, is to statistically analyze the data to group or sort it into meaningful categories of much smaller size, to pare the dataset down to one or more useful subsets that can be extracted or applied by the researcher in reasonable fashion. For example, gene-expression microarray studies often produce in the neighborhood of 20,000 or more rows of data that must be sorted through to find meaningful, important or interesting results in the context of the experiment being performed. Even after reducing such a dataset to those genes which are meaningful as being differentially expressed, which is a typical approach, the researcher is still often left with hundreds to thousands of genes (rows) to interpret. Statistical methods may be used as an approach to further reducing this subset, by grouping the data into clusters or based on other relational similarities. Such analysis may be based upon the expression values themselves, but other approaches focus on characterizations of the genes producing the data, such as annotations.

One such approach, by Doniger et al., as described in “MAPPFinder: using Gene Ontology and GenMAPP to create a global gene-expression profile from microarray data”, Genome Biology, vol. 4, Issue I, Article R7, 2003, uses a tool to create a global gene-expression profile across all areas of biology by integrating the annotations of the Gene Ontology (GO) Project with GenMAPP (http://www.GenMAPP.org). A searchable browser is provided which enables a user to identify GO terms with over-represented numbers of gene-expression changes. This approach, while potentially useful, appears to be limited to directly searching the Gene Ontology (GO) terms themselves. The Gene Ontology (GO) Consortium is creating a defined vocabulary of terms (GO terms) describing biological processes, cellular components and molecular functions of all genes. Curators at the public gene databases are assigning genes to GO terms to provide annotation and a biological context for individual genes. Although identifying GO terms with over-represented numbers of gene-expression changes may effectively reduce a dataset to a much more workable size, and may provide some useful results, it is by no means a comprehensive approach. For example, there may be relationships between GO terms that occur in over-represented numbers that may be meaningful in identifying interesting groups of genes, which would be missed by this approach. As another example, there may be an over-represented occurrence of differentiated genes that may be identified by only portions of various GO terms, such as descriptions of cellular components.

Al-Shahrour et al. provide a procedure for extracting Go terms that are significantly over or under-represented in sets of genes within the context of a genome-scale experiment, see “FatiGO: a web tool for finding significant associations of Gene Ontology terms with groups of genes”, http://fatigo.bioinfo.cnio.es. This approach is also limited to directly searching the Gene Ontology (GO) terms themselves.

Thus, while some progress has been made for extracting subsets of data from large scale datasets based on searching GO terms for overrepresentations of such, there remains a need for more universal methods of extracting meaningful subsets of data from large scale datasets.

### SUMMARY OF THE INVENTION

The present invention provides systems, methods and computer readable media for facilitating user-guidance of computation analysis and knowledge extraction tools, giving a user the ability to analyzing word-based textual annotations associated with data in a large dataset to identify one or more meaningful subsets of the large dataset based upon the analysis of the word-based textual annotations.

A large dataset, with its data provided in matrix format, wherein rows of the matrix are arranged according to a first characteristic set of the data and columns of the matrix are arranged according to a second characteristic set of the data is provided, and wherein each cell in a row of the data has the same first characteristic from the first characteristic set, and each cell in a column of the data has the same second characteristic from the second characteristic set. At least one row or column of word-based textual annotations characterizing said dataset is also provided, wherein a row of word-based textual annotations characterizes the columns of the matrix and a column of word-based textual annotations characterizes the rows of the matrix.

Systems methods tools and computer readable media are provided for rearranging the columns or rows of the matrix, and any associated columns or rows of word-based textual annotations effected by the rearrangement of the columns or rows of the matrix, based on selecting at least one data value in a column or row of the matrix, respectively, and sorting based upon the at least one selected data value. At least one subset of data is selected based upon results of the rearranging of the columns or rows of the matrix. A column or row of word-based textual annotations (depending upon whether the rearrangement was performed as to rows or columns, respectively) is selected for a statistical analysis, and a statistical analysis of term frequency of occurrence of terms contained in the word-based-textual annotations associated with the columns or rows of the matrix is then performed, relative to term frequency of occurrence of terms contained in the word-based textual annotations associated with the rows or columns in the at least one selected subset. One or more meaningful subsets of the at least one selected subset are then identified, based on the statistical analysis.

Prior to the statistical analysis of term occurrence, a procedure may be run to remove all duplicate occurrences of entries to be examined by the analysis, based on duplicate occurrences of a first characteristic in the matrix, when the analysis is to be performed with respect to rows of the matrix, or on duplicate occurrences of a second characteristic, when the analysis is to be performed with respect to columns of the matrix. This feature is useful, for example when rows of gene expression data are to be analyzed, to ensure that replicate gene probes are not considered in the analysis.

With respect to removal of duplicate occurrences, another column of annotations (typically, other than the column selected for the frequency of occurrence of terms analysis, although it is possible to select the same column) associated with the rows of data, may be selected as a basis for removing all duplicate occurrences when the analysis is to be performed with respect to the rows of the matrix, and a row of annotations (typically other than the row selected for the frequency of occurrence of terms analysis, although it is possible to select the same row) associated with the columns of data, may be selected as a basis for removing all duplicate occurrences when the analysis is to be performed with respect to the columns. An appropriate column for such a selection contains a unique identifier for each first characteristic represented in the first characteristic set. An appropriate row for such a selection contains a unique identifier for each second characteristic represented in the second-characteristic set.

Statistical analysis may be based on Z-scores, p-values or other statistical tests, wherein the identification of one or more meaningful subsets from the at least one selected subset is based on selecting rows or columns meet or exceed a predetermined Z-score.

The present invention is particularly suited for large biological datasets, although not limited thereto. Non-limiting examples of large biological datasets that the present systems, methods, tools and recordable media are useable with include gene expression datasets and CGH datasets. Columns or rows of annotations associated with the datasets may include references to associations with curated or non-curated networks, associations with literature, or other word-based annotations.

Selections of the at least one subset of the dataset may be interactively performed by a user through a user interface provided. Similarly, selection of a column or row of the word-based textual annotations may be interactively performed by a user through a user interface provided. Selection of a column or row for removal of duplicate occurrences may also be interactively performed by a user through a provided user interface.

These and other advantages and features of the invention will become apparent to those persons skilled in the art upon reading the details of the systems, methods, tools and computer readable media as more fully described below.

### BRIEF DESCRIPTION OF THE DRAWINGS

FIG. 1 is a schematic representation of a view of a portion of a microarray gene expression dataset for processing according to the present invention.

FIG. 2 shows a user interface for selecting a column of word-based textual annotations to be statistically analyzed with regard to the dataset of FIG. 1, according to the present invention.

FIG. 3 shows a user interface for selecting a column of annotations with unique identifiers for use in eliminating duplicate occurrences of genes listed in the rows of the dataset of FIG. 1, among other functionalities.

FIG. 4A shows a portion of a table listing the results of a statistical analysis performed with regard to single word terms according to the present invention.

FIG. 4B shows a portion of a table listing the results of a statistical analysis performed with regard to both single word terms and word pair terms according to the present invention.

FIG. 5 shows a portion of a table listing the results of another statistical analysis performed according to the present invention.

FIG. 6 shows a portion of a table listing the results of still another statistical analysis performed according to the present invention.

FIG. 7 shows comparative genomic hybridization (CGH) data plotted relative to chromosome maps, wherein the CGH data may be analyzed according to the present invention.

FIG. 8. shows a portion of a table listing the results of a statistical analysis performed with regard to CGH data.

FIG. 9 is a schematic, functional block representation of a typical computer system which may be employed in carrying out the present invention.

### DETAILED DESCRIPTION OF THE INVENTION

Before the present methods, systems and computer readable media are described, it is to be understood that this invention is not limited to particular statistical methods, user interfaces, hardware, software, method steps or datasets described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a column” includes a plurality of such columns and reference to “the subset” includes reference to one or more subsets and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### DEFINITIONS

The term “cell”, when used in the context describing a data table or heat map, refers to the data value at the intersection of a row and column in a spreadsheet-like data structure or heat map; typically a property/value pair for an entity in the spreadsheet, e.g. the expression level for a gene.

“CGH data” refers to data obtained from “Comparative Genomic Hybridization” measurements. CGH involves a technique that measures DNA gains or losses. Some techniques perform this at the chromosomal level, while newer emerging techniques, such as “Array CGH” (aCGH) use high throughput microarray measurements to measure the levels of specific DNA sequences in the genome. While not specifically limited to aCGH data, the present invention is applicable to aCGH data, which comes in a form analogous to array-based gene expression measurements.

“Color coding” refers to a software technique which maps a numerical or categorical value to a color value, for example representing high levels of gene expression as a reddish color and low levels of gene expression as greenish colors, with varying shade/intensities of these colors representing varying degrees of expression. Color-coding is not limited in application to expression levels, but can be used to differentiate any data that can be quantified, so as to distinguish relatively high quantity values from relatively low quantity values. Additionally, a third color can be employed for relatively neutral or median values, and shading can be employed to provide a more continuous spectrum of the color indicators.

The term “data mining” refers to a computational process of extracting higher-level knowledge from patterns of data in a database. Data mining is also sometimes referred to as “knowledge discovery”.

The term “down-regulation” is used in the context of gene expression, and refers to a decrease in the amount of messenger RNA (mRNA) formed by expression of a gene, with respect to a control.

“Gel electrophoresis” refers to a biological technique for separating and measuring amounts of protein fragments in a sample. Migration of a protein fragment across a gel is proportional to its mass and charge. Different fragments of proteins, prepared with stains, will accumulate on different segments of the gel. Relative abundance of the protein fragment is proportional to the intensity of the stain at its location on the gel.

The term “gene” refers to a unit of hereditary information, which is a portion of DNA containing information required to determine a protein's amino acid sequence.

“Gene expression” refers to the level to which a gene is transcribed to form messenger RNA molecules, prior to protein synthesis.

“Expression data” or “gene expression data” refers to quantitative representations of gene expressions.

“Gene expression ratio” is a relative measurement of gene expression, wherein the expression level of a test sample is compared to the expression level of a reference sample.

A “gene product” is a biological entity that can be formed from a gene, e.g. a messenger RNA or a protein.

A “heat map” or “heat map visualization” is a visual representation of a tabular data structure of gene expression values, wherein color-codings are used for displaying numerical values. The numerical value for each cell in the data table is encoded into a color for the cell. Color encodings run on a continuum from one color through another, e.g. green to red or yellow to blue for gene expression values. The resultant color matrix of all rows and columns in the data set forms the color map, often referred to as a “heat map” by way of analogy to modeling of thermodynamic data.

A “hypothesis” refers to a provisional theory or assumption set forth to explain some class of phenomenon.

An “item” refers to a data structure that represents a biological entity or other entity. An item is the basic “atomic” unit of information in the software system.

The term “mass spectrometry” refers to a set of techniques for measuring the mass and charge of materials such as protein fragments, for example, such as by gathering data on trajectories of the materials/fragments through a measurement chamber. Mass spectrometry is particularly useful for measuring the composition (and/or relative abundance) of proteins and peptides in a sample.

A “microarray” or “DNA microarray” is a high-throughput hybridization technology that allows biologists to probe the activities of thousands of genes under diverse experimental conditions. Microarrays function by selective binding (hybridization) of probe DNA sequences on a microarray chip to fluorescently-tagged messenger RNA fragments from a biological sample. The amount of fluorescence detected at a probe position can be an indicator of the relative expression of the gene bound by that probe.

The term “biological network”, “network” or “network diagram” refers to a biological diagram depicting at least one relationship between at least two biological items.

A “curated network” is a network that has been manually verified and represents some known (or assumed known) biological process.

A “non-curated network” is a network that is inferred from automatic analyses, such as interactions and associations derived from literature and experimental data (such as Bayesian inference from microarray data, Y2H studies, etc.), or added manually based on some assumptions and hypotheses and hence is not verified. Note that a network can also be partially curated, wherein, some of the interactions (relationships) in the network are curated, but others are not.

The term “normalize” refers to a technique employed in designing database schemas. When designing efficiently stored relational data, the designer attempts to reduce redundant entries by “normalizing” the data, which may include creating tables containing single instances of data whenever possible. Fields within these tables point to entries in other tables to establish one to one, one to many or many to many relationships between the data. In contrast, the term “de-normalize” refers to the opposite of normalization as used in designing database schemas. De-normalizing means to flatten out the space efficient relational structure resultant from normalization, often for the purposes of high speed access that avoid having to follow the relationship links between tables.

The term “promote” refers to an increase of the effects of a biological agent or a biological process.

A “protein” is a large polymer having one or more sequences of amino acid subunits joined by peptide bonds.

The term “protein abundance” refers to a measure of the amount of protein in a sample; often done as a relative abundance measure vs. a reference sample.

“Protein/DNA interaction” refers to a biological process wherein a protein regulates the expression of a gene, commonly by binding to promoter or inhibitor regions.

“Protein/Protein interaction” refers to a biological process whereby two or more proteins bind together and form complexes.

The term “pseudo-data vector” refers to a vector containing pseudo values based on inputs by a user of the system, which is constructed for performing similarity sorts against actual data vectors generated from a dataset.

A “sequence” refers to an ordered set of amino acids forming the backbone of a protein or of the nucleic acids forming the backbone of a gene.

The term “overlay” or “data overlay” refers to a user interface technique for superimposing data from one view upon data in a different view; for example, overlaying gene expression ratios on top of a compressed matrix view.

A “spreadsheet” is an outsize ledger sheet simulated electronically by a computer software application; used frequently to represent tabular data structures.

The term “up-regulation”, when used to describe gene expression, refers to an increase in the amount of messenger RNA (mRNA) formed by expression of a gene, with respect to a control.

The term “UniGene” refers to an experimental database system which automatically partitions DNA sequences into a non-redundant sets of gene-oriented clusters. Each UniGene cluster contains sequences that represent a unique gene, as well as related information such as the tissue types in which the gene has been expressed and chromosome location.

The term “view” refers to a graphical presentation of a single visual perspective on a data set.

The term “visualization” or “information visualization” refers to an approach to exploratory data analysis that employs a variety of techniques which utilize human perception; techniques which may include graphical presentation of large amounts of data and facilities for interactively manipulating and exploring the data.

A “word” as used herein as a basis for statistical analysis refers to a unit of text separated by delimiters. Thus, a word includes but is not limited to generally accepted linguistic terms, but also includes terms such as “K1”, “MAPK3” or any other term set off by delimiters within an entry. A delimiter may be a tab, space, comma, hyphen, period or other punctuation mark, for example.

A “word pair”, “bi-word” or “double word” refers to tow words separated by a space, hyphen or period, for example.

“Terms” refer to words, word pairs, multiple words, or combinations thereof.

When one item is indicated as being “remote” from another, this is referenced that the two items are at least in different labs, offices or buildings, and may be at least one mile, ten miles, or at least one hundred miles apart.

“Communicating” information references transmitting the data representing that information as electrical signals over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic or optical disk may carry the programming, and can be read by a suitable disk reader communicating with each processor at its corresponding station.

“May” means optionally.

Methods recited herein may be carried out in any order of the recited events which is logically possible, as well as the recited order of events.

All patents, patent applications and other references cited in this application, are incorporated into this application by reference except insofar as they may conflict with those of the present application (in which case the present application prevails).

Reference to a singular item, includes the possibility that there are plural of the same items present.

Methods recited herein may be carried out in any order of the recited events which is logically possible, as well as the recited order of events.

The present invention provides systems, tools, methods and computer readable media for analyzing textual annotations to data contained in large datasets, by performing a statistical analysis of term frequency. Specific examples are provided for analyzing textual gene annotations by performing a statistical analysis of term frequency, although the invention is not limited to use with gene data. Particularly effective uses of the present methods, systems, tools and computer readable media have been experienced with regard to analyzing Gene Ontology annotations, portions thereof, and/or generic gene descriptions.

The present systems, tools and methods manipulate very large data structures, generally in the form of tabular or spreadsheet type data structures, to organize relevant data for ready visualization by a user attempting to visually identify correlations, trends or other insights among the data. Although the techniques described below use manipulation of heat map visualizations as an example of how the invention can be used, the invention is not limited to heat maps or gene expression data, as any numerical data can be accommodated with the methods and tools described herein.

Both a statistical framework and an integrated software user interface are provided that enable researchers to interactively manipulate large datasets (e.g., gene expression data, protein abundance data or other large datasets) and rapidly answer biological questions based on analysis of textual annotations (e.g., GO terms, portions of GO terms, annotations linking the data with network diagrams, annotations linking the data with scientific literature, or other text annotations).

The present invention performs a statistical analysis of term frequency, and thus can be applied not only to GO terms, but to portions of GO terms (e.g., the words or word pairs used in any combination or all of the words describing the associated biological processes, cellular components and molecular functions of the genes which are associated with the GO terms), or words or word pairs (i.e., double words) contained in any other annotations that include words. Thus, such statistical analysis is not limited to the Gene Ontology entries, but can be applied to any textual annotation associated with the genes measured in a microarray experiment, or to any textual annotations associated with any other large dataset. Any annotations that include descriptive terms therefore can be used to perform a statistical analysis as described herein. Thus, for experiments or organisms for which GO annotations are unavailable, analysis is still possible. Exemplary annotations that may be used include proprietary text annotations, descriptive gene names, cytoband information, information regarding the occurrence of data in curated and/or non-curated networks, associations of data with items in external literature, or any other annotations including descriptive and discriminating words.

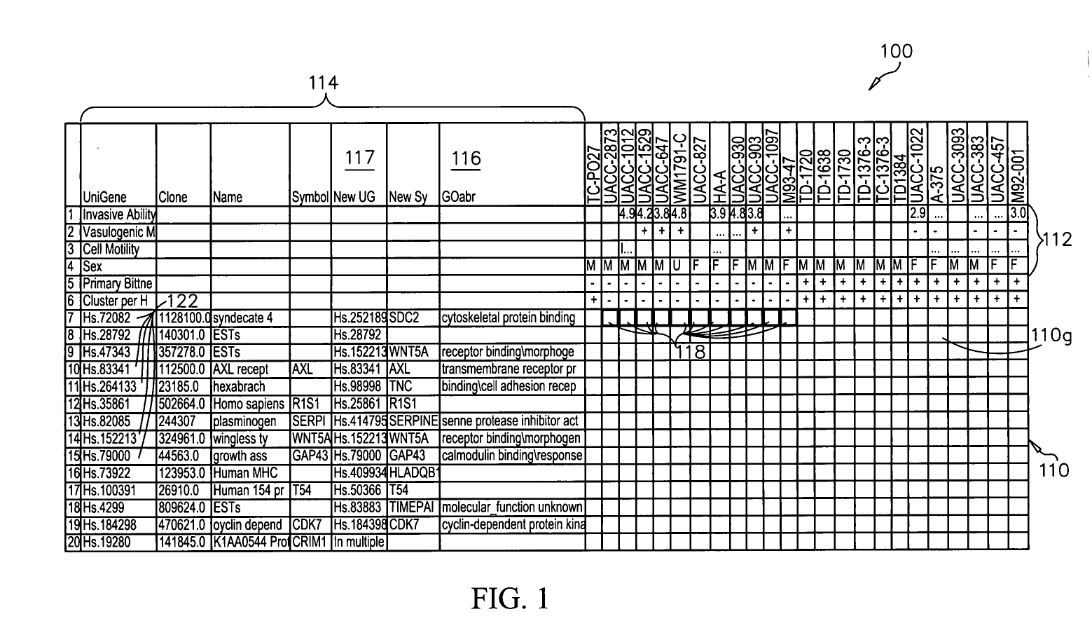

Turning now to FIG. 1, a schematic representation of a portion of a screen shot 100 is shown, displaying microarray gene data for a set of melanoma experiments. The tool used in this example is VistaClara (Agilent Technologies, Inc., Palo Alto, Calif.), which is described in greater detail in co-pending, commonly owned application Ser. No. 10/403,762 filed Mar. 31, 2003 and titled “Methods and System for Simultaneous Visualization and Manipulation of Multiple Data Types” and in co-pending, commonly owned application Ser. No. 10/688,588 filed Oct. 18, 2003 and titled “Methods and System for Simultaneous Visualization and Manipulation of Multiple Data Types”. Both application Ser. No. 10/403,762 and application Ser. No. 10/688,588 are hereby incorporated herein, in their entireties, by reference thereto. However, it should be noted here that the present invention is not limited to the use of VistaClara for providing a subset of interesting data from a large dataset for use in further processing, as any tool capable of discriminating such an interesting (to the user) subset of data from a large dataset may be employed. Although not practical, such a subset could even be provided by manually sorting through a large dataset to identify one or more interesting subsets.

In the schematic representation, only fourteen rows of experimental data are shown, as limited by drawing requirements as to the minimum character sizes that can be used. In reality, the view 100 will typically display fifty-five to sixty rows of data in uncompressed format which is still readily viewable and readable by a user. However, the entire dataset, as mentioned earlier, may typically contain 20,000 or more rows of data.

Getting back to the example of FIG. 1, the dataset is provided with both rows 112 and columns 114 of annotations which further characterize the data. Among the columns 114 of annotation in this example is a column of GO terms 116, which will be referred to in an example of use of the present invention below. However, the system, principles, tools and methods described herein may be applied to any column of textual annotations characterizing experiments, or any row of textual annotations characterizing experiments, when there are enough experiments to make the number of cells in such row statistically valid. In such cases, an ordering of the columns of experimental data may be performed and then a sampling of one or more rows of text data may be performed in a similar manner to that described below with regard to sampling one or more columns.

In this example, a similarity sorting process was run in VistaClara to create a biologically meaningful ordering of the data. In this example, the melanoma data 110 was sorted based on those microarray experiments that corresponded to invasive strains of the melanoma. The cells 118 which were selected as a basis of the sort are shown highlighted in FIG. 1. The result of the similarity sort shows a band of cells the majority of which are red 110r for the rows displayed at the top of the dataset (i.e., including those shown in FIG. 1) for the sorted genes, in the experimental columns underlying the selected cells 118. In contrast, the majority of the cells underlying the non-selected columns are color-coded green 110g. This color-coding confirms that the sort has produced a subset of genes at the top of the dataset, which are up-regulated genes in the invasive sub-group of experiments, while largely down-regulated or neutral in the remaining experiments. Rows 122 were identified as those genes found by external studies to be informative of this sub-group of the experiments.

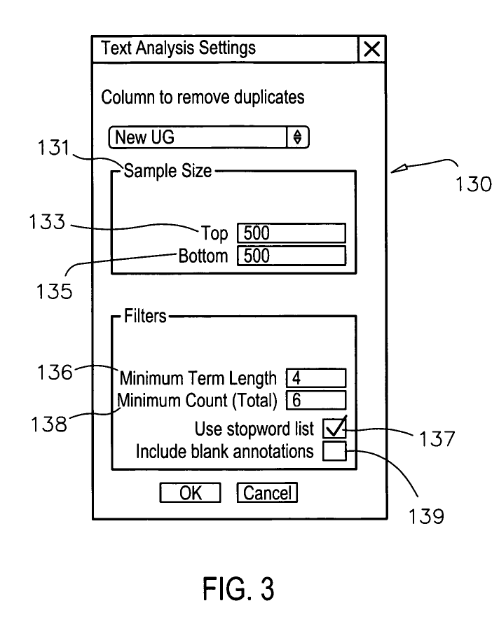

By selecting on the column of Gene Ontology annotations 116, the system statistically analyzes the annotations 116 for the frequency of occurrence of words used in the annotations. The system provides a user interface 130 by which the user may specify the sample size 133 (e.g., number of rows) for both the top 133 and bottom 135 samples. In the example shown in FIG. 3, both the bottom and top samples have been set to five hundred rows. However, it is possible to set the bottom (or top) sample to any positive integer, such that the sum of the bottom and top sample sizes is less than or equal to the total number of rows in the dataset. Also, either the top 133 or bottom 135 sample sizes may be set to zero, if the user is only interested in examining either the top or the bottom of the list. Also, the numbers inputted for top 133 and bottom 135 sample sizes do not have to be equal. The selected sampling size is typically determined after the user examines the sort results, wherein the color-coding of the cells may visually indicate a general estimate of the number of rows at the top (and/or) bottom of the sorted list that may be similarly differentially expressed.

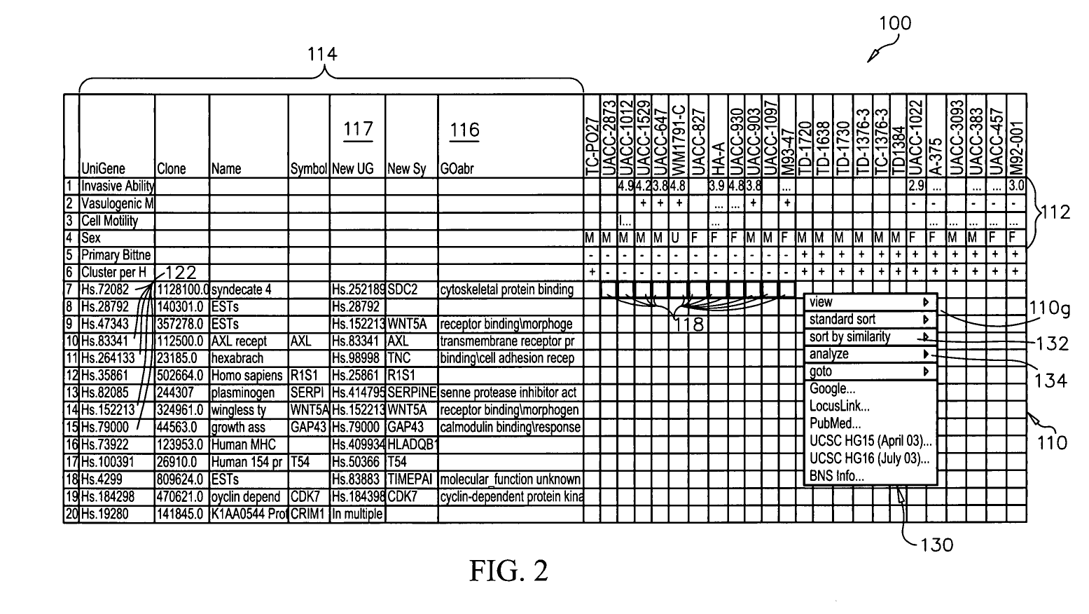

A menu or other user interface 130 is provided not only to perform the sort 132 (e.g., see FIG. 2), but to perform the statistical analysis 134, among other functions. Various locations may be selected as a basis from which to perform the statistical analysis. In this instance, the statistical analysis is selected to be performed based upon the text in the selected column, which in this example was selected to be the column of GO terms 116. In this case, five hundred rows of genes were sampled from the top of the list, and five hundred rows of genes were sampled from the bottom of the list. The top five hundred rows corresponded to the genes most up regulated in the sub group as opposed to the most down regulated genes in the bottom five hundred rows in the dataset 100.

As noted above, the sampling sizes may be selected by the user, and sampling sizes may be based on a visual inspection of the sorted data which may reveal (i.e., through color-coding trends in the sorted data) where strong correlations tend to diminish. If the ordering is based on computational scoring of the genes (e.g., SAM scores or other computational scoring), then a statistically significant cutoff may be determined by visual inspection, or further computation, including internal computation by the system.

Alternatively, as also noted above, the bottom five hundred genes in the sorted list need not be analyzed at the same time, or at all, depending upon the user's interest. The user interface 130 allows setting arbitrary values to the top and bottom sample sizes and either one can be set to zero if there is not an interest in examining that top or bottom sample. In some instances, if the sort uses the Pearson correlation as the distance measure, information about the anti-correlated genes (those at the bottom of the sorted list) may be provided as well.

In addition to providing for user inputs to set sample sizes 133,135, user interface 130 also provides filters which may be set by the user to tailor the results reported after performing the statistical analysis. For example, a “minimum term length” filter 136 may be optionally interactively set by a user to prevent any term having a length (i.e., number of characters) shorter (smaller) than the number of characters specified, from being reported. Further optionally, the user may set a “minimum count number” filter 138 to establish a lower limit for the number of occurrences of a term that are reported. Thus, where the minimum count filter is set to 6, as in the example of FIG. 3, any term that occurs less than six times in the total data set will not be reported. If the “Use stopwords list” box 137 is checked by the user, then the system does not report results contained on the stopword list, which are typically words that have little information content, such as a, the, molecule, DNA, etc. The stopword list may be edited to add or remove stopwords from the list to provide further flexibility and tailoring to a specific task.

Another option provided to the user by user interface 130 is whether or not to include blank annotations. The system's algorithm normally ignores lines with no annotations during processing, since the absences of an annotation is not informative and cannot be included in the statistical processing. However, if the lack of an annotation is somehow informative to the user, such as when the lack of an annotation is intentional and represents a classification in and of itself, then consideration of this classification by the algorithm may be included during processing, when the user checks the “Include blank annotations” box 139 prior to processing. In such an instance, the frequency of entries having no annotations will be considered in the statistical analysis.

In addition to providing for the user to select to begin the statistical analysis and the basis upon which the statistical analysis will be performed, as described above, user interface also provides for an interactive user selection of a set of annotation data to be used to remove duplicate entries of the data that is to be statistically analyzed. In the example shown in FIG. 3, the user has selected the column 117 (NewUG) in the duplicates removal menu 140, to be used as a basis for removing duplicate genes. Column 117 (NewUG) contains a Unigene identifier for each gene. Selections are not limited to Unigene identifiers, but may be made from any column that contains a unique gene identifier for each gene, such as gene symbols, GenBank accession numbers, clone ID's, etc. This step is important to the accuracy of the results provided by the statistical analysis, to ensure that no particular gene is counted more than once, as may occur if there are replicate probes on the microarray experiments, for example.

Still further, although the examples shown in the Figs. perform statistical analyses based upon the occurrences of single words in the annotations and/or on the analysis of word pairs, the system may also be adapted to analyze for strings of words (i.e., terms containing greater that two words). With regard to the examples describing analysis of word pairs, processing of word pairs may be identified or based upon adjacent words that are separated by a space, hyphen or period, for example. Thus, for example, the system may calculate occurrences of “protein binding” (word pair analysis), as well as, or alternatively to occurrences of “protein” and “binding” (single word analyses). In some situations, such as the example provided, word pairings may be actually more statistically important than occurrences of the single words making up the pairings, but not always.

The calculations for the statistical analysis are preformed very rapidly, returning the results of the statistical analysis to the user for continued study. An example of the statistical analysis that may be performed by the present invention, and which was used in the example described above is based on Z-scores. Z-scores are a measure of statistical relevance and are generically defined as:

$$Z ( x ) = \frac{x - μ}{σ} \qquad ( 1 )$$

where for sample value x, μ is the mean and σ is the standard deviation of the population. This scoring has been extended for textual analysis according to the present invention as follows:

$$Z ( r ) = \frac{( r - n \frac{R}{N} )}{\sqrt{n ( \frac{R}{N} ) ( 1 - ( \frac{R}{N} ) ) ( 1 - \frac{n - 1}{N - 1} )}} \qquad ( 2 )$$

where
N=the total number of entries measured (in the example above, the total number of genes after removing replicates)
R=the total number of entries meeting the criterion (in the example above, the number of genes that have been found through the sort to be differentially expressed with regard to the criterion selected for sorting)
n=the total number of entries containing a specific term, and
r=the number of entries containing a specific term and which meet the criterion.

A similar approach is taken for the statistical analysis of networks for scoring the statistical significance of such networks for use with experimental data in co-pending, commonly owned application Ser. No. ______ (Application Serial No. not yet assigned, Attorney's Docket No. 10040118-1) filed concurrently herewith and titled “Methods and Systems for Extension, Exploration, Refinement, and Analysis of Biological Networks”. Application Ser. No. ______ (Application Serial No. not yet assigned, Attorney's Docket No. 10040118-1) is hereby incorporated herein, in its entirety, by reference thereto.

Additionally, continuing with the above example, a column of annotations may be provided in association with the dataset 110 to indicate where occurrences of the specific rows (genes) have been found to occur in curated and/or non-curated network diagrams. For example, a researcher may have access to a library of one hundred network diagrams, each of which were converted to a local format such as ALFA in a manner described in application Ser. No. ______ (Application Serial No. not yet assigned, Attorney's Docket No. 10040118-1). A column listing the networks where each specific gene occurs may be generated by converting the gene names listed in the rows to the local format and searching the networks to identify such occurrences. The occurrences may then be listed as a string of “words” in the column of annotations. Thus, for example, if the networks are identified as K1-K100 and the gene listed in row 10 was found to occur in networks K3, K25 and K27, then the entry in the annotation column for row 10 would include the string “K3, K25, K27”. These annotations may then be analyzed for statistical significance in the same manner described above with regard to the analysis of GO terms.

As another example, a column of annotations may be provided to describe associations of the particular genes in the literature. For example, a software tool know as BioFerret (available from Agilent Technologies, Inc., Palo Alto, Calif.), which is described in detail in co-pending, commonly assigned application Ser. No. 10/033,823 filed Dec. 19, 2001 and titled “Domain-Specific Knowledge-Based Metasearch System and Methods of Using”, may be used to generate a list of associations between genes from scientific literature. application Ser. No. 10/033,823 is incorporated herein, in its entirety, by reference thereto. However, a number of other means, such as a keyword search of PubMed or other scientific database(s), for example, may be used to identify a corpus of relevant textual documents. Further, the text corpus may be processed to extract associations between various genes and converted to ALFA objects, as described in the methods provided in co-pending, commonly assigned application Ser. No. 10/154,524 filed May 22, 2002 and titled “System and Method for Extracting Pre-Existing Data from Multiple Formats and Representing Data in a Common Format for Making Overlays”. Application Ser. No. 10/154,524 is hereby incorporated herein, in its entirety, by reference thereto. In this example, Bioferret was used and one or more textual databases (e.g., PubMed or the like) were searched for textual documents containing references to specific genes. Sentences referring spacifically to the particular genes (i.e., “genes of interest”) were extracted and converted to ALFA objects using the methods described in application Ser. No. 10/154,524. Every gene that is associated with each gene extracted from the literature was stored as the extracted gene's literature association annotation. Thus, for example, if there are one thousand genes of interest (G1-G1000) that the system has information about, and a gene listed in row ten of the experimental data was found, by the above-described data mining, to be associated with genes G23, G150, G151, G152 and G753 in various scientific literature articles, then the entry in the literature annotation for row ten would include the string “G23, G150, G151, G152, G753”. The literature annotations may then be analyzed for statistical significance in the same manner described above with regard to the analysis of GO terms and network annotations. By comparing the results for two or more different analyses, such as by comparing the results to the analyses regarding GO terms, network annotations, and scientific literature annotations, a finding of similarity of results may greatly strengthen a researcher's hypothesis that biological significant information may have been identified or discovered. On the other hand, if the compared results are substantially contrasting, this may motivate the researcher to do further research in an effort to explain the disparities, modify data sources that are found to be erroneous, such as literature or network sources, or develop new models that achieve similar results through the various analysis techniques.

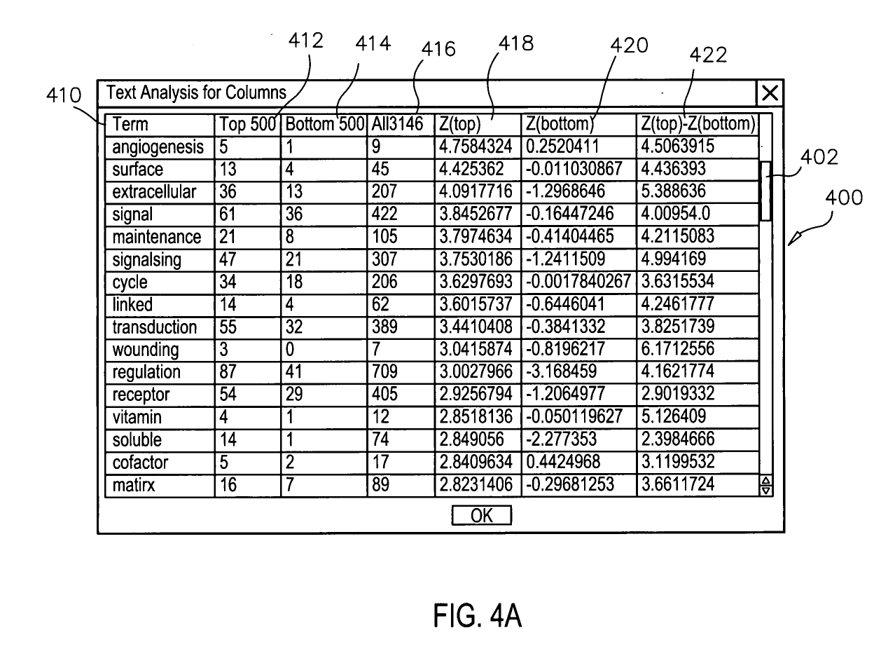

FIG. 4A is an exemplary screen display summarizing the results of the statistical analysis for the GO term example described above, wherein only single word terms were analyzed. In this example, the results are presented in table 400 format. It is noted that not all of the results were able to be displayed on the screen at the same time, but the user may scroll from the highest scoring results at the top of the screen, down to the bottom of the list by manipulating scroll bar 402.

In this example, columns are provided in the displayed table 400 for “Term” 410, “Top 500” 412, “Bottom 500” 414, “All 3146” 416, “Z(top)” 418, “Z(bottom)” 420 and “Z(top)−Z(bottom)” 422. Of course, the categories for the columns displayed may vary depending upon the specifics of the statistical analysis performed. In this example, Term 410 refers to the word that was extracted from the annotations (i.e., word extracted from the GO terms in this example). “Top 500” 412, or, more generally, Top N 500 refers to the number or count of the occurrences of the term in the first N entries, i.e., the top subset of data identified from the entire dataset. “Bottom 500” 414, or more generally, Bottom N 414 refers to the number or count of occurrences of the term in the last N entries of the dataset (usually these are anti-correlated with respect to the top list).

“All 3146” 416, or, more generally, All N 416 refers to the number or count of occurrences of the term in the entire dataset (N entries, in this case 3146). By these presentations, the user can visually compare how many counts are found in the top or bottom subsets compared to the total number of counts in the entire dataset.

Z(top) 418 provides the Z scores based on sampling the top N rows (in this example, the top five hundred rows) of the ordered list of the entire dataset. Z(bottom) 420 reports the Z scores based on sampling the bottom N rows (in this example, the bottom five hundred rows) of the ordered list of the entire dataset. Z(top)−Z(bottom) 422 displays a calculation of the difference between the Z(top) 418 and the Z(bottom) 420 scores, to facilitate the ease of use by the user.

Note that all of the statistics reported in the table of FIG. 4A were collected based on unique gene entries, as noted above, where duplicates (e.g., replicates) are removed based on the identifier specified by the user. Any column of word-based text annotations may be selected by the user to identify scores or counts of term occurrences and their statistical significance scores (e.g., Z-scores).

The top scoring term in this analysis, i.e., “angiogenesis”, indicates that genes associated with the word angiogenesis are statistically over-abundant in the up-regulated genes. This is a satisfying result since, in this example, it was already know that the sub-group selected (i.e., the known invasive strains) for sorting is known to represent cell lines with a high degree of “vasculogenic mimicry” (shown in row 2 of FIG. 1).

It is further interesting to note that while the prior art processes discussed above would be capable of statistically analyzing the GO terms 116 shown in FIG. 2, the results of such analysis would only show which full GO terms are abundant in the list. However, in this example, no single full GO term 116 from FIG. 2 which contains the bi-word “receptor binding” occurs with great frequency, and therefore the prior art techniques would not reveal any direct relationship between the data and this term. However, many different GO terms 116 in FIG. 2 do contain the bi-word “receptor binding”, and the present invention discovers this fact.

FIG. 4B is an exemplary screen display summarizing the results of the statistical analysis for the GO term example described above, wherein both single word term analysis and word pair term analysis were performed. In this example, the results are presented in table 400′ format. It is noted that not all of the results were able to be displayed on the screen at the same time, but the user may scroll from the highest scoring results at the top of the screen, down to the bottom of the list by manipulating scroll bar 402.

In this example, Term 410 includes not only the single word terms that were extracted from the annotations, but also word pair terms that were extracted. (i.e., single word terms and word pair terms extracted from the GO terms in this example). The remaining columns 412-422 retain the same meaning as described above with regard to FIG. 4A. It is interesting to note that word pairs “receptor linked” and “surface receptor” were calculated to have even higher Z scores that “angiogenesis” in this example.

The bottom pane 440 shown in FIG. 4B displays the members of the dataset that are associated with the annotations having been found to include the term that the user selects in the top pane 400′. In the example shown, the user has highlighted the term “angiogenesis”, in column 410. Column 442 (row) identifies the row numbers in which the term occurs. Column 444 (group) identifies whether that particular row was in the top or bottom sample analyzed. Those cells that are blank in this column indicate that the particular row w neither in the top or bottom sample. Further, a user can select (or “click on”) a row in pane 440 and, in response, the system automatically scrolls to that row entry in the display 100 so that the user can see the full experimental values in dataset 110. This provides reverse navigation back to the interesting data (e.g., genes) found by the analysis.

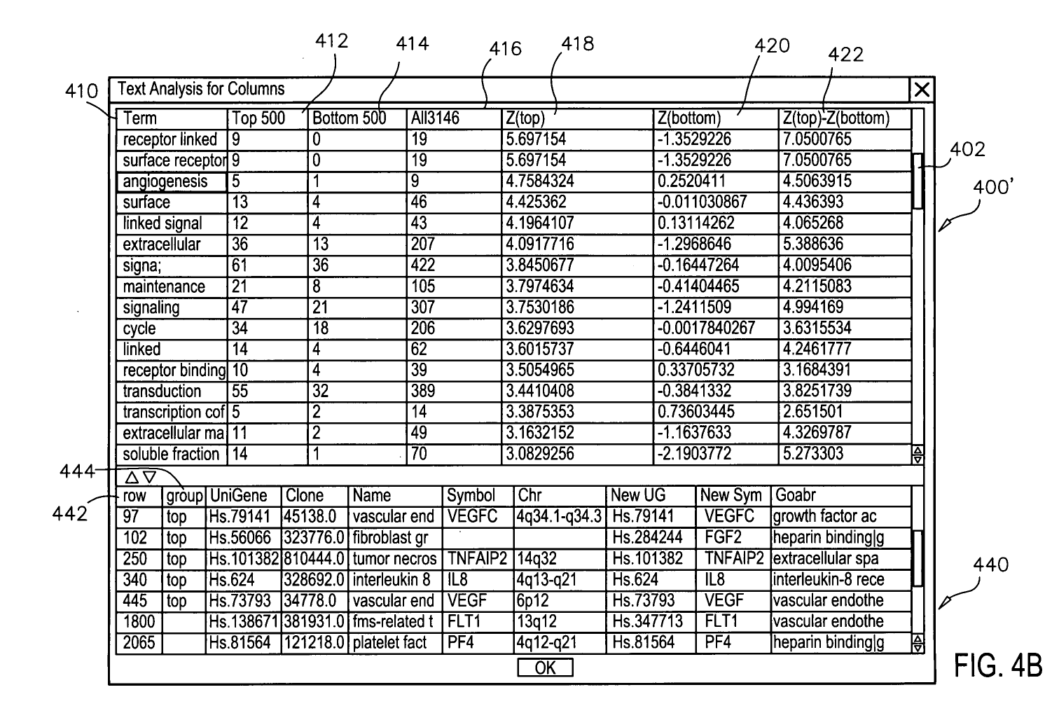

As another example of the current techniques, analysis was performed on a public dataset of fruit fly development, see Arbeitman et al., “Gene expression during the life cycle of Drosophila melanogaster”. Science, vol. 297, pp. 2270-2275, 2002. Initially, the dataset was similarity sorted by the Pearson similarity technique with VistaClara. The dataset was then sorted by the genes found to be highly expressed in the adult stage. Next the GO annotations were statistically analyzed for single word frequency (sampling the top 500 genes and bottom 500 genes. The results are shown in FIG. 5. The top scoring genes in this example are all related to the eye (as characterized by the words phototransduction, rhodopsin, rhabodomere). In fact Arbeitman et al. show that genes associated with eye development are more highly expressed in the adult stage than during any of the previous development stages.

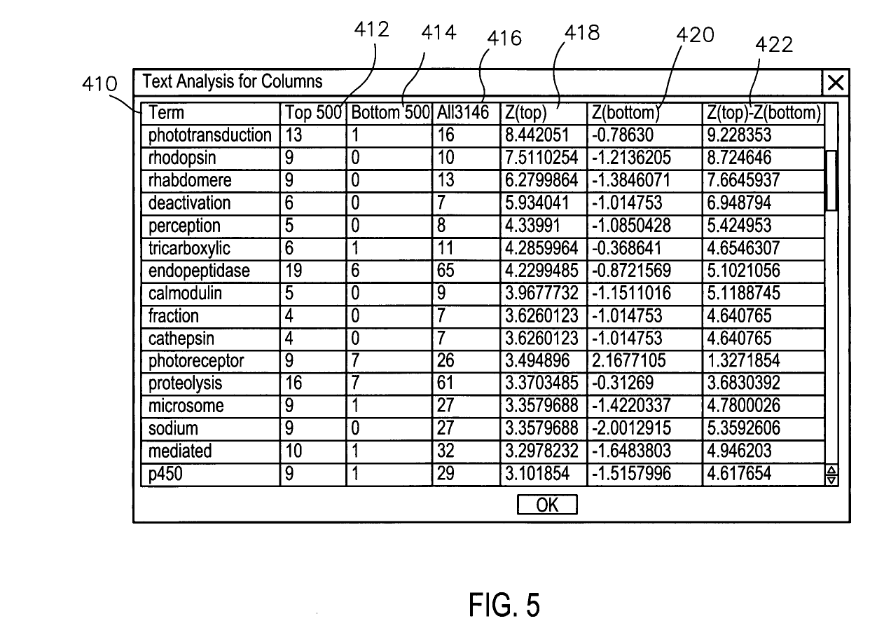

FIG. 6. shows the results for a similar analysis, but for those genes highly up-regulated during early stages of embryo development. A similarity sort was performed against a pattern corresponding to genes up-regulated in the first nine time-ordered tissue samples (characterizing the early embryo stage) and down-regulated over the remaining time-ordered tissue samples. Again the results of the present techniques support or agree with what is reported by Arbeitman, et al., as those terms (words) with the highest scores are related to nuclear functions, cell division and cell cycle. One expects these to be in abundance during the rapid cell division taking place in early development.

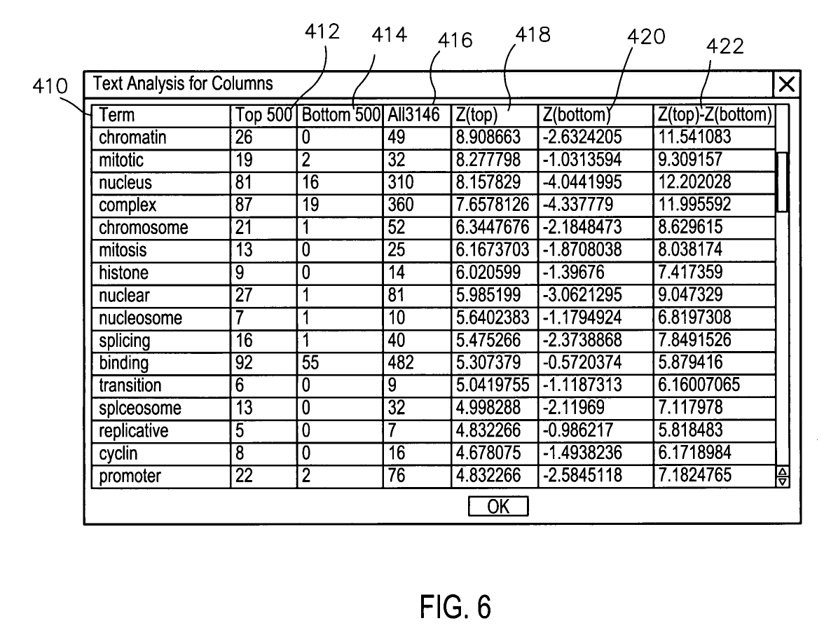

As noted above, the present invention may be applied to analysis of annotations other than GO terms. Referring now to FIG. 7, comparative genomic hybridization (CGH) data is considered for analysis. CGH data was obtained for a number of human breast tumors by Pollack et al., “Microarray analysis reveals a major direct role of DNA copy number alteration in the transcriptional program of human breast tumors”, Proc. Natl. Acad. Sci. USA, vol. 99, pp. 12963-8, 2002. FIG. 7 shows plots 700 of CGH measurements for several genes with one sample (BT474). In each of these cases there are several strong peaks, e.g., 702,702,706,708,710,712 indicating increased copy numbers along stretches of genomic regions shown. By looking at the ideograms it can be observed that the cytobands associated with the peaks appear to be amplified as identified by peaks 702,702,706,708,710,712 adjacent those cytobands.

The same data was loaded into VistaClara, along with text annotations describing the cytobands, in order to perform a statistical analysis on the textual annotations for determining which cytobands are over-represented in high ratios. The CGH data is represented by VistaClara as a heat map-style representation (i.e., color-coded cells) indicating degrees of abundance. CGH data, like gene expression data, is represented as ratio data, but in this case the ratios are measures of DNA (as opposed to mRNA with gene expression data) ratios of presumably diseased cells versus “normal” cells. The presumably diseased cells may show additional copies of a particular chromosome region, or may show deletions (i.e., absence) of a region. The CGH data is handled in VistaClara the same way as described above with regard to gene expression data, and all the previously described visualization options, manipulations and features are equally applicable to use with CGH data.

To perform the analysis, VistaClara was first used to sort the dataset for gene BT474 so that high ratio CGH data results in the top subset of the dataset. This time, a more stringent subset size was applied, such that only two hundred fifty genes on the top of the sorted list were defined as the highly differentiated subset. As in previous examples, a bottom subset was also analyzed, this time the bottom set was composed of two hundred fifty genes.

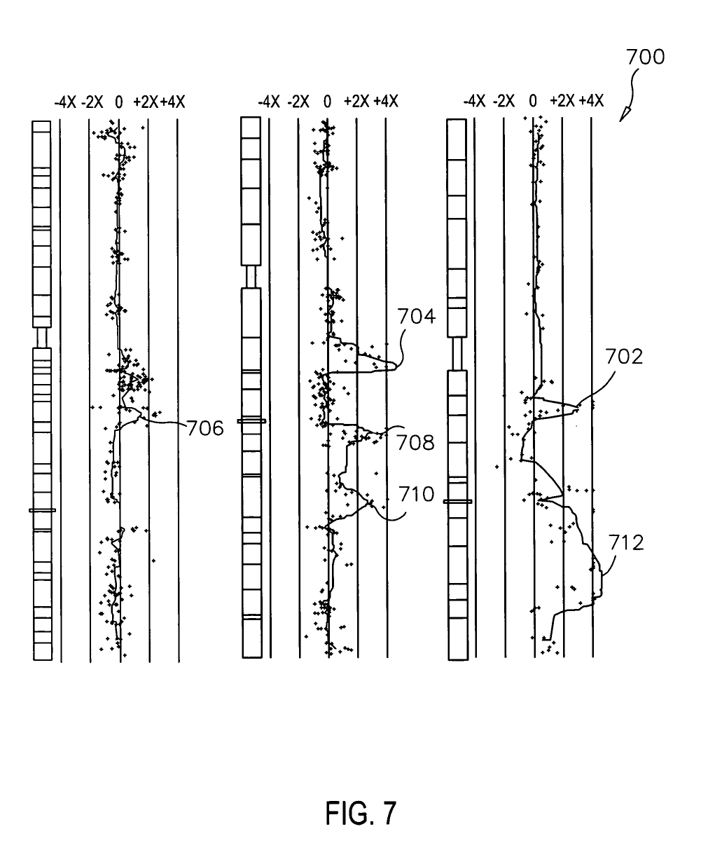

FIG. 8 shows results from this analysis. The top three cytobands in the results (20q13, 11q13 and 17q21) are in agreement with the most obvious CGH events found in FIG. 7. The remaining cytobands with significant Z scores are also found by analyzing the CGH data by standard methods. As a general guide, Z scores greater than or equal to about 3 may be considered significant. However, this is just a general guide, and the user may decide to consider only those scores which are clearly separated from the remaining scores, according to the user's judgment after visual examination of the scores. For example, a user may choose to select only those scores above 5, when there are no scores in the 4 range and some scores in the low 3's and below. Thus, the extremely simple and fast user interface interactions allow the user to process the data to quickly extract at least a high level picture of the major copy increases. To analyze the bottom subset (in this example, Bottom 250), the list may be sorted by column 420 to see which genes are over and under represented by looking at the high and low Z-scores in column 420, respectively. Thus, the system may also find and identify cytobands with significant copy number decreases.

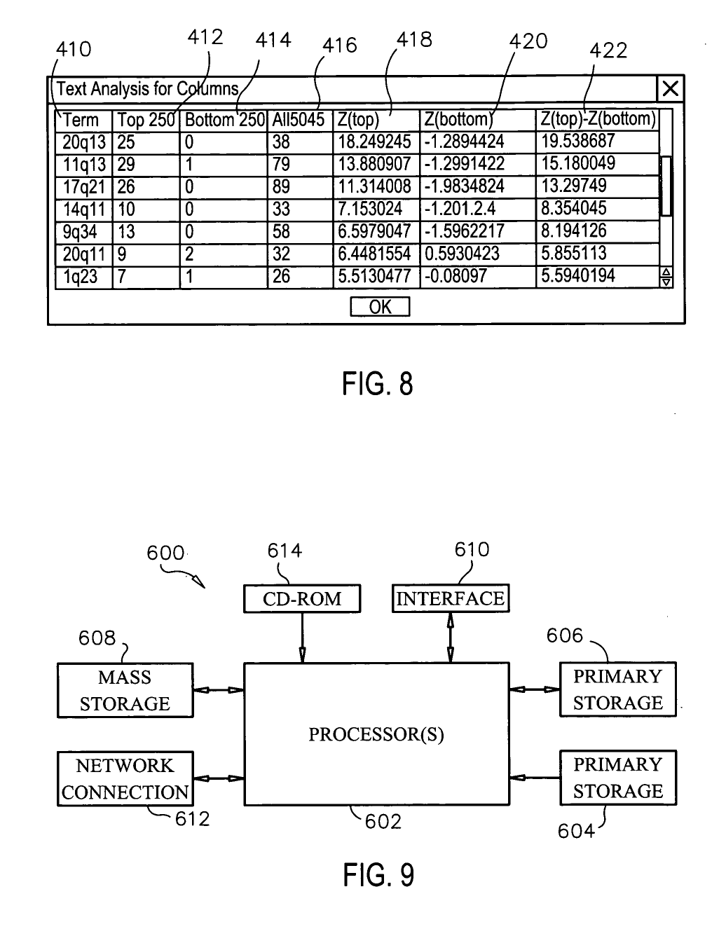

FIG. 9 illustrates a typical computer system which may be employed in carrying out the present invention. The computer system 600 may include any number of processors 602 (also referred to as central processing units, or CPUs) that are coupled to storage devices including primary storage 606 (typically a random access memory, or RAM), primary storage 604 (typically a read only memory, or ROM). As is well known in the art, primary storage 604 acts to transfer data and instructions uni-directionally to the CPU and primary storage 606 is used typically to transfer data and instructions in a bi-directional manner Both of these primary storage devices may include any suitable computer-readable media such as those described above. A mass storage device 608 is also coupled bi-directionally to CPU 602 and provides additional data storage capacity and may include any of the computer-readable media described above. Mass storage device 608 may be used to store programs, data and the like and is typically a secondary storage medium such as a hard disk that is slower than primary storage. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to a computer or telecommunications network using a network connection as shown generally at 612. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for converting data types to the local format may be stored on mass storage device 608 or 614 and executed on CPU 608 in conjunction with primary memory 606, and one or more interfaces 610 (e.g., video displays) may be employed in displaying the viewer operations discussed herein.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

While the present invention has been described with reference to the specific embodiments thereof, it should be understood by those skilled in the art that various changes may be made and equivalents may be substituted without departing from the true spirit and scope of the invention. More specifically, while this invention is described in the context of the VistaClara user interface, and a scoring mechanism based on Z-scores, it should be understood that the basic invention does not require either of these. Alternative statistical measures can be used (for example that described by Spellman and Rubin, “Evidence for large domains of similarly expressed genes in the Drosophila genome”, Journal of Biology, Vol. I, Issue 1, Article, 2002, which is hereby incorporated herein, in its entirety, by reference thereto, and which uses a hypergeometric function. Other methods can be used to select sub groups for sampling (for example sampling a cluster in a hierarchically clustered data set, or by sorting a gene list by Significance Analysis of Microarrays (SAM) scores, for example, a technique which is described by Tusher et al. in “Significance analysis of microarrays applied to the ionizing radiation response”, Proc. Nat. Acad. Sci. USA, vol. 98, pp 5116-5121, 2001, which is hereby incorporated herein, in its entirety, by reference thereto. Further, the present invention is not limited to processing using the VistaClara user interface, but can be performed via Perl scripts, or other application frameworks. Many modifications may be made to adapt a particular dataset, hardware, software, process, process step or steps, to the objective, spirit and scope of the present invention. All such modifications are intended to be within the scope of the claims appended hereto.

1. A method of analyzing word-based textual annotations associated with data in a large dataset to identify one or more meaningful subsets of the large dataset based upon the analysis of the word-based textual annotations, said method comprising the steps of:
providing the data of the large dataset in a matrix format wherein rows of the matrix are arranged according to a first characteristic set of the data and columns of the matrix are arranged according to a second characteristic set of the data, each cell in a row having the same first characteristic from the first characteristic set, and each cell in a column having the same second characteristic from the second characteristic set;
providing at least one row or column of word-based textual annotations characterizing said dataset, wherein a row of word-based textual annotations characterizes said columns of the matrix and a column of word-based textual annotations characterizes said rows of the matrix;
rearranging the columns or rows of the matrix, and any associated columns or rows of word-based textual annotations effected by said rearranging the columns or rows of the matrix, based on selecting at least one data value in a column or row of the matrix, respectively, and sorting based upon said at least one selected data value;
selecting at least one subset of the dataset based upon results of said rearranging the columns or rows of the matrix;
selecting a column of said word-based textual annotations when said at least one subset is made up of rows of data, or a row of said word-based textual annotations when said at least one subset is made up of columns of data;
statistically analyzing term frequency of occurrence of terms contained in said word-based-textual annotations associated with said columns or rows in said matrix, relative to term frequency of occurrence of terms contained in said word-based textual annotations associated with said rows or columns in said at least one selected subset; and
identifying one or more meaningful subsets of said at least one selected subset based on the statistical analysis.

2. The method of claim 1, further comprising: prior to said statistically analyzing, removing all duplicate occurrences said first characteristics in the matrix, when the statistical analysis is to be performed with respect to said rows of the matrix, and removing all duplicate occurrences of said second characteristics, when the statistical analysis is to be performed on columns of the matrix.

3. The method of claim 2, further comprising selecting a column of annotations associated with said rows of data, as a basis for said removing all duplicate occurrences when the statistical analysis is to be performed with regard to said rows, and selecting a row of annotations associated with said columns of data, as a basis for said removing all duplicate occurrences when the statistical analysis is to be performed with regard to said columns, wherein said selected column of annotations contains a unique identifier for each first characteristic represented in said first characteristic set, and wherein said selected row of annotations contains a unique identifier for each second characteristic represented in said second characteristic set.

4. The method of claim 2, wherein said statistically analyzing term frequency comprises Z-scoring the term frequencies of occurrence according to the following formula:
$$Z ( r ) = \frac{( r - n \frac{R}{N} )}{\sqrt{n ( \frac{R}{N} ) ( 1 - ( \frac{R}{N} ) ) ( 1 - \frac{n - 1}{N - 1} )}} \qquad ( 2 )$$
where
N=the total number of entries in the large dataset, after removal of said duplicate occurrences;
R=the total number of entries meeting a selected criterion;
n=the total number of entries containing a specific term having been analyzed by said term frequency of occurrence analysis; and
r=the number of entries containing a specific term and which meet the criterion.

5. The method of claim 4, wherein said identifying one or more meaningful subsets of said at least one selected subset based on the statistical analysis is based on selecting rows or columns as part of said one or more meaningful subsets that meet or exceed a predetermined Z-score.

6. The method of claim 5, wherein said predetermined Z-score is 3.

7. The method of claim 1, wherein said large dataset comprises biological data.

8. The method of claim 1, wherein said large dataset comprises gene expression data and wherein said selected column or row of word-based textual annotations comprises gene ontology annotations.

9. The method of claim 7, wherein said selected column or row of word-based textual annotations comprises identifications of occurrences of said biological data in network diagrams.

10. The method of claim 7, wherein said selected column or row of word-based textual annotations comprises identifications of occurrences of said biological data in external literature sources.

11. The method of claim 1, further comprising performing the steps of claim 1 with regard to at least one other row or column of word-based textual annotations, and, comparing results identified by a first performance of the steps of claim 1 with at least one set of results identified by said performing the steps of claim 1 with regard to at least one other row or column of word-based textual annotations.

12. The method of claim 11, said statistically analyzing term frequency of occurrence comprises analyzing single words within said gene ontology annotations.

13. The method of claim 11, said statistically analyzing term frequency of occurrence comprises analyzing word pairs within said gene ontology annotations.

14. The method of claim 1, wherein said selecting at least one subset of the dataset is based upon user input, through a user interface, specifying the number of rows or columns in each subset.

15. The method of claim 1, wherein said selecting a column or row of said word-based textual annotations is initiated through a user interface by a user.

16. The method of claim 1, wherein said rearranging the columns or rows is performed by a similarity sort based on a selection of at least data value in at least one cell in one of said columns or rows.

17. The method of claim 1, wherein said first characteristic set comprises gene names and said second characteristic comprises experiment numbers.

18. The method of claim 7, wherein said biological data comprises CGH data.

19. A method comprising forwarding a result obtained from the method of claim 1 to a remote location.

20. A method comprising transmitting data representing a result obtained from the method of claim 1 to a remote location.

21. A method comprising receiving a result obtained from a method of claim 1 from a remote location.

22. A system for analyzing word-based textual annotations associated with data in a large dataset to identify one or more meaningful subsets of the large dataset based upon the analysis of the word-based textual annotations, said system comprising:
means for receiving a large dataset comprising data in a matrix format wherein rows of the matrix are arranged according to a first characteristic set of the data and columns of the matrix are arranged according to a second characteristic set of the data, each cell in a row having the same first characteristic from the first characteristic set, and each cell in a column having the same second characteristic from the second characteristic set, and at least one row or column of word-based textual annotations characterizing said dataset, wherein a row of word-based textual annotations characterizes said columns of the matrix and a column of word-based textual annotations characterizes said rows of the matrix;
means for rearranging the columns or rows of the matrix, and any associated columns or rows of word-based textual annotations effected by said rearranging the columns or rows of the matrix, based on a selection of at least one data value in a column or row of the matrix, respectively, and sorting based upon said at least one selected data value;
means for selecting at least one subset of the dataset based upon results of said rearranging the columns or rows of the matrix;
means for selecting a column of said word-based textual annotations when said at least one subset is made up of rows of data, or a row of said word-based textual annotations when said at least one subset is made up of columns of data;
means for statistically analyzing term frequency of occurrence of terms contained in said word-based-textual annotations associated with said columns or rows in said matrix, relative to term frequency of occurrence of terms contained in said word-based textual annotations associated with said rows or columns in said at least one selected subset; and
means for identifying one or more meaningful subsets of said at least one selected subset based on the statistical analysis.

23. The system of claim 22, further comprising means for removing all duplicate occurrences said first characteristics, prior to the statistical analysis, when the statistical analysis is to be performed with regard to rows of the matrix, and removing all duplicate occurrences of said second characteristics, when the statistical analysis is to be performed with regard to columns of the matrix.

24. The system of claim 23, further comprising a user interface for interactively selecting a column of annotations associated with said rows of data, as a basis for said removing all duplicate occurrences when the statistical analysis is to be performed with regard to said rows, and for interactively selecting a row of annotations associated with said columns of data, as a basis for said removing all duplicate occurrences when the statistical analysis is to be performed with regard to said columns, wherein said selected column of annotations contains a unique identifier for each first characteristic represented in said first characteristic set, and wherein said selected row of annotations contains a unique identifier for each second characteristic represented in said second characteristic set.

25. The system of claim 22, wherein said means for selecting at least one subset comprises a user interface for interactively selecting said at least one subset.

26. The system of claim 22, wherein said means for selecting a column or row of said word-based textual annotations comprises a user interface for interactively selecting said at least one column or row of said word-based textual annotations.

27. The system of claim 22, further comprising means for displaying said one or more meaningful subsets.

28. The system of claim 22, further comprising means for displaying at least a portion of said large subset in a heat-map style representation.

29. The system of claim 22, wherein said means for statistically analyzing term frequency of occurrence statistically analyzes based on Z-scoring.

30. A computer readable medium carrying one or more sequences of instructions for analyzing word-based textual annotations associated with data in a large dataset to identify one or more meaningful subsets of the large dataset based upon the analysis of the word-based textual annotations, wherein data of the large dataset is provided in a matrix format, wherein rows of the matrix are arranged according to a first characteristic set of the data and columns of the matrix are arranged according to a second characteristic set of the data, each cell in a row having the same first characteristic from the first characteristic set, and each cell in a column having the same second characteristic from the second characteristic set, wherein at least one row or column of word-based textual annotations characterizing said dataset is provided, wherein a row of word-based textual annotations characterizes said columns of the matrix and a column of word-based textual annotations characterizes said rows of the matrix, and wherein execution of one or more sequences of instructions by one or more processors causes the one or more processors to perform the steps of:
rearranging the columns or rows of the matrix, and any associated columns or rows of word-based textual annotations effected by said rearranging the columns or rows of the matrix, based on selecting at least one data value in a column or row of the matrix, respectively, and sorting based upon said at least one selected data value;
selecting at least one subset of the dataset based upon results of said rearranging the columns or rows of the matrix;
selecting a column of said word-based textual annotations when said at least one subset is made up of rows of data, or a row of said word-based textual annotations when said at least one subset is made up of columns of data;
statistically analyzing term frequency of occurrence of terms contained in said word-based-textual annotations associated with said columns or rows in said matrix, relative to term frequency of occurrence of terms contained in said word-based textual annotations associated with said rows or columns in said at least one selected subset; and
identifying one or more meaningful subsets of said at least one selected subset based on the statistical analysis.

31. The computer readable medium of claim 30, wherein execution of one or more sequences of instructions by one or more processors causes the one or more processors to perform the further step of removing all duplicate occurrences sad first characteristics, prior to the statistical analysis, when the statistical analysis is to be performed with regard to rows of the matrix, and removing all duplicate occurrences of said second characteristics, prior to the statistical analysis, when the statistical analysis is to be performed with regard to columns of the matrix.

32. The computer readable medium of claim 31, wherein execution of one or more sequences of instructions by one or more processors causes the one or more processors to perform the further step of selecting a column of annotations associated with said rows of data, as a basis for said removing all duplicate occurrences when the statistical analysis is to be performed with regard to said rows, and selecting a row of annotations associated with said columns of data, as a basis for said removing all duplicate occurrences when the statistical analysis is to be performed with regard to said columns, wherein said selected column of annotations contains a unique identifier for each first characteristic represented in said first characteristic set, and wherein said selected row of annotations contains a unique identifier for each second characteristic represented in said second characteristic set.
